(19) United States
(12) Patent Application Publication
(10) Pub. No.: US 2018/0191721 A1
(43) Pub. Date: Jul. 5, 2018

(54) MECHANISMS TO ENABLE SECURE VIRTUAL NAMESPACES IN DISAGGREGATED STORAGE TARGETS

(71) Applicant: Intel Corporation, Santa Clara, CA (US)

(72) Inventors: James P. Freyensee, Hillsboro, OR (US); Jawad B. KHAN, Cornelius, OR (US); Thomas R. BOWEN, Albuquerque, NM (US); Robert M. VARNUM, Beaverton, OR (US)

(21) Appl. No.: 15/396,519

(22) Filed: Dec. 31, 2016

(51) Int. Cl. H04L 29/06; H04L 9/08

(52) U.S. Cl. CPC H04L 63/10; H04L 63/0281; H04L 63/0471; H04L 2209/76; H04L 9/0866; H04L 9/0822; H04L 63/0428

(57) ABSTRACT

Embodiments are generally directed to mechanisms to enable secure virtual namespaces in disaggregated storage targets. An embodiment of an apparatus includes a processor to process data; a memory for the storage of data; an interface with a host system over a communication fabric; an interface with each of one or more endpoint devices to provide storage for the host system; and a virtual target, the virtual target to map the one or more endpoint devices to multiple namespaces for the host system. The apparatus is operable to support secure access to the namespaces, the secure access including encryption of data transferred between the host system and a namespace, the data encryption key being derived from an identification of the host system; and present the plurality of namespaces to the host system in the virtual target.

### TECHNICAL FIELD

Embodiments described herein generally relate to the field of electronic devices and, more particularly, mechanisms to enable secure virtual namespaces in disaggregated storage targets.

### BACKGROUND

Aggregated storage systems such as RAID (Redundant Array of Inexpensive Disks) systems provided data storage virtualization to combine multiple disks in a volume or logical unit, providing advantages in terms of data redundancy and system performance.

Storage solutions are now evolving to different structures, which may include access to disparate types of storage elements that are accessed locally or remotely in cloud storage.

However, aggregate storage systems such as RAID and disaggregated storage targets provide only limited secure access control enforced from the storage system target up to the host systems that utilize that storage. Aggregated storage solutions such as hardware RAID controllers generally support only a simple locking mechanism using a single password/credential for the entire volume. Such conventional mechanisms may be inadequate to address access security in a system utilizing varying storage endpoints for host system access.

### BRIEF DESCRIPTION OF THE DRAWINGS

Embodiments described here are illustrated by way of example, and not by way of limitation, in the figures of the accompanying drawings in which like reference numerals refer to similar elements.

FIG. 1 is an illustration of a system to provide secure access to virtual namespaces according to an embodiment;

FIG. 2 is an illustration of an exemplary architecture of a secure NVMe host and virtual NVMe target to provide translation table mapping to generic endpoints according to an embodiment;

FIG. 3 illustrates an exemplary architecture of a virtual NVMe target with target-enforced access control according to an embodiment;

FIG. 4 illustrates an exemplary architecture of a virtual NVMe target with proxy-based access control according to an embodiment;

FIG. 5 illustrates implementation by a virtual NVMe target of a 1:1 host-to-namespace mapping according to an embodiment;

FIG. 6 illustrates implementation by a virtual NVMe target of a T>H host-to-namespace mapping according to an embodiment;

FIG. 7 illustrates implementation by a virtual NVMe target of an H>T host-to-namespace mapping according to an embodiment; and

FIG. 8 is an illustration of a system to provide a virtual target for a host system according to an embodiment.

### DETAILED DESCRIPTION

Embodiments described herein are generally directed to mechanisms to enable secure virtual namespaces in disaggregated storage targets.

For the purposes of this description:

“Endpoint” or “endpoint device” refers to a physical device or sub-section of a physical device to provide storage.

In some embodiments, an apparatus, system, or process enables secure access to systems that act as endpoints to a storage system by:

(1) Providing secure access to virtual namespaces via encryption and key-wrapping; and

(2) Presenting the virtual namespaces in a target system with aggregated or disaggregated storage devices to a host system over a communication fabric. The communication fabric may include RDMA (Remote Direct Memory Access), PCIe (Peripheral Component Interconnect Express), TCP/IP (Transmission Control Protocol/Internet Protocol), etc.

In some embodiments, an apparatus, system or method provides the virtual NVMe (Non-Volatile Memory Express, also referred to as NVM Express) namespaces to one or more NVMe hosts by providing management of virtual namespace solution in an NVMe target solution using aggregated or disaggregated storage devices. NVMe is a logical device interface specification for accessing non-volatile storage media attached via PCI Express (PCIe) bus. See “NVM Express”, Revision 1.2.1 (Jun. 5, 2016) and “NVM Express Over Fabrics”, Revision 1.0 (Jun. 5, 2016). The PCIe bus may operate according to the Peripheral Component Interconnect (PCI) Express Base Specification, revision 3.1a, published in December 2015 (“PCI Express specification” or “PCIe specification”).

In some embodiments, an apparatus or system enables a secure, disaggregated NVMe-over-Fabrics storage solution to securely access virtual namespaces to host systems, as well as encrypt the data written to those virtual namespaces in a datacenter through encryption key management, regardless of the number or type of storage devices that are present as endpoints. In some embodiments, the secure solution may include application of NIST (National Institute of Standards and Technology) Special Publication 800-38F, “Recommendation for Block Cipher Modes of Operation: Methods for Key Wrapping”, M. Dworkin (December 2012).

Aggregated storage solutions such as hardware RAID controllers generally only support a simple locking mechanism using a single password/credential for the entire volume. In some embodiments, by implementing per-namespace access control, an apparatus, system, or method is to enhance the simple locking mechanism to allow each NVMe host to possess its own credential so that tenant isolation is improved. Among other advantages, the speed of operation may be enhanced by providing an effective and efficient secure access mechanism that is applied based on the capabilities of each physical endpoint device.

Each of the embodiments presented herein may be implemented in hardware (such as a translation table implemented in hardware on an FPGA (Field Programmable Gate Array) or ASIC (Application Specific Integrated Circuit) with hardware encryption engines); software (such as a translation table and namespaces virtualized in an operating system with software encryption algorithms and access policies), or a combination of both hardware and software, including firmware.

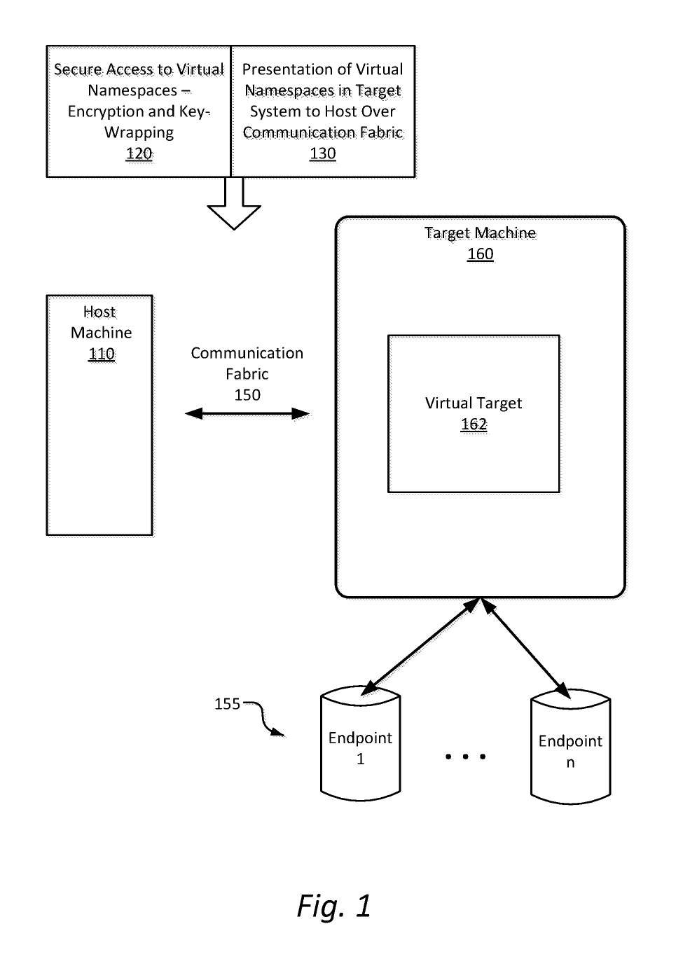

FIG. 1 is an illustration of a system to provide secure access to virtual namespaces according to an embodiment. As illustrated in FIG. 1, a host machine 110 (which may generally be referred to as the host) is to access a virtual target 162 (the virtual target) via a target machine 160 (the target). In some embodiments, the target machine 160 includes an interface with the host machine 110 and with each of one or more endpoints 155. In some embodiments, the target machine 160 is to present the one or more endpoints 155 for storage, shown as Endpoint 1 through Endpoint n, as a set of virtual namespaces, wherein the number of virtual namespaces may be equal to, greater than, or less than the number of endpoints. The endpoints are devices or sub-sections of devices to provide storage. In some embodiments, an endpoint is a device or sub-section of a device to provide data storage that a virtual NVMe target can use to provide a virtual NVMe namespace to an NVMe host. The endpoints 155 may include, but are not limited to, SSD (Solid State Drive) devices, USB (Universal Serial Bus) devices, and files such as OS (Operating System) files for an apparatus or system.

In some embodiments, the system illustrated in FIG. 1 is to provide secure access to virtual namespaces via encryption and key-wrapping 120; and is to present the virtual namespaces in the target machine 160 with the aggregated or disaggregated storage devices to the host machine 110 over a communication fabric 150.

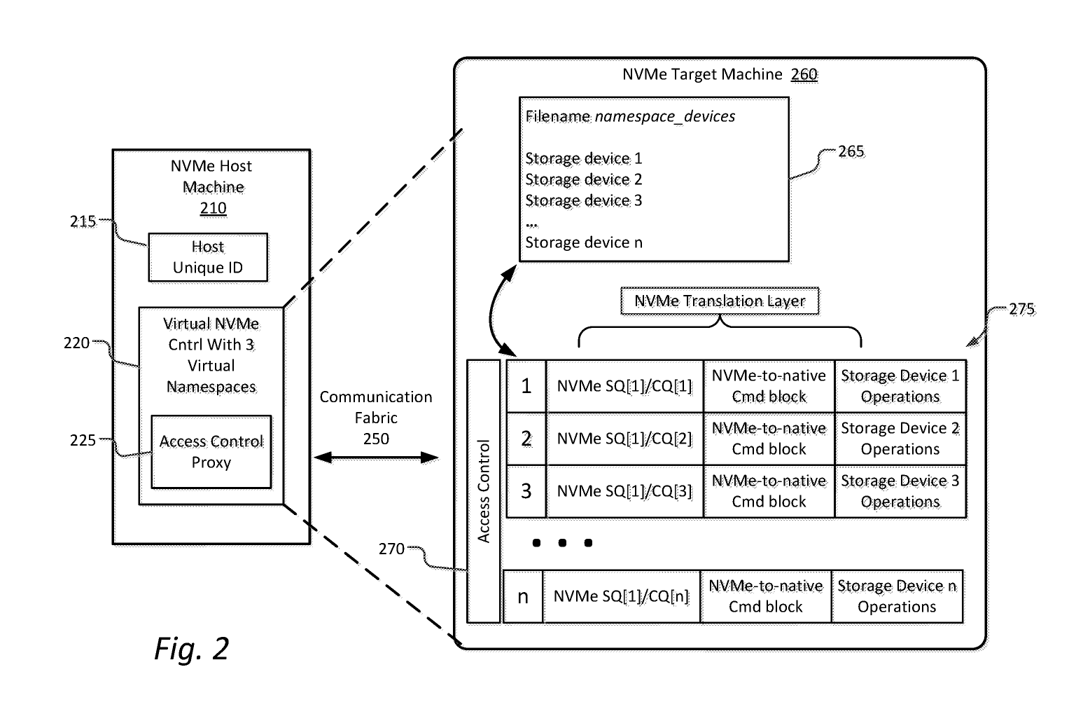

FIG. 2 is an illustration of an exemplary architecture of a secure NVMe host and virtual NVMe target to provide translation table mapping to generic endpoints according to an embodiment. In some embodiments, a management solution such as illustrated in FIG. 2 not only provides virtual NVMe namespaces in a system with storage devices that may or may not contain NVMe devices in that system, but also provides a secure policy via encryption/key-wrappings such that a single host can access the namespace and interpret the contents of that namespace.

In some embodiments, an NVMe host is to apply its unique name identifier, as specified in the NVMe specification, to securely access and encrypt data sent to an endpoint within a virtual NVMe target provided by an NVMe target machine over a communication fabric. The virtual NVMe target provides a translation table mapping that allows an NVMe host to connect to an endpoint that may or may not be an actual NVMe device. The table mapping allows the virtual NVMe target to hide the actual number and types of devices being securely accessed by the NVMe host. In this example, the NVMe target is unaware that the NVMe host is encrypting the data written to the virtual namespaces, and an NVMe host receives access to only the virtual namespaces that are allocated to it.

As illustrated in FIG. 2, an NVMe host machine 210 includes a host unique identification (ID) 215 and a virtual NVMe controller 220, the virtual NVMe controller including three virtual namespaces in the illustrated example. In some embodiments, the NVMe host machine 210 is to utilize its unique ID 215 to provide a secret value to an access control proxy 225 for data encryption.

In some embodiments, the NVMe host machine 210 operates under the impression that the NVMe host machine 210 has a local NVMe controller with 3 namespaces, while in reality the actual controller may be located in another location, such in a data center. The access control proxy 225 may be utilized by the NVMe host machine 210 to authenticate the NVMe host machine and derive a data encryption key that will be used to encrypt all data transferred between the NVMe host machine 210 and the particular selected namespace the NVMe host machine is accessing.

In some embodiments, the NVMe host machine 210 is linked by a communication fabric 250 to an NVMe target machine 260, the NVMe target machine 260 being responsible for presenting the virtual NVMe controller 220 to the NVMe host machine 210. In some embodiments, the NVMe target machine 260 is to hide the details of what storage endpoint devices are actually being used, and hence is referred to as having a virtual NVMe target. For ease of illustration, the specific endpoint devices are not illustrated in FIGS. 2-7, but include a variety of different storage devices and sections or devices, such as the endpoints 155 illustrated in FIG. 1.

In some embodiments, the NVMe target machine 260 uses a list of devices 265 in a file to create virtual NVMe namespaces to present to the NVMe host machine 210. Each line in the file creates a new entry in a translation table 275. The translation table 275 is used by the NVMe target machine 260 to route NVMe I/O (input/output) transactions to their respective physical storage device, i.e., the respective endpoint.

In some embodiments, access control 270 may be enforced at the virtual NVMe target machine 260 by encrypting all data written to and read from each exposed namespace prior to transferring data to or from the endpoint devices actually storing the NVMe host machine's data. Read or write requests from other hosts that do not have access privileges to a given namespace will return either an error or encrypted data to order to combat brute force attacks and data corruption.

More specifically, access control for the namespaces is provided by encrypting each of the namespaces reported to the NVMe host machine 210 with a data encryption key (DEK). Each DEK is encrypted using AES (Advanced Encryption Standard) with a key encryption key (KEK). The KEK is derived via the unique ID (or Host NVMe Qualified Name (NQN)) of the NVMe host machine 210 to the endpoint device, which allows the endpoint device to decrypt one or more DEKs, granting the NVMe host machine 210 access to one or more virtualized namespaces. In some embodiments, the DEKs may be permanently stored within the virtual NVMe target because the DEKs require an external key or credential in order to unlock access to any of the data within the virtualized namespace. The credential or key used to derive the KEK must not be stored within the system, but can be retrieved via a standard key management system such as the Key Management Interoperability Protocol (KMIP). The access control mechanism can be supported by the endpoint device by implementing an interface such as the TCG (Trusted Computing Group) Opal management interface. See “TCG Storage Security Subsystem Class: Opal Version 2.01 Revision 1.00 (Aug. 5, 2015); “TCG Storage Opal Integration Guidelines”, Version 1.00, Revision 1.00 (Mar. 16, 2016).

In some embodiments, there are three cases for various configurations of the number of namespaces presented to the NVMe host machine 210 by the virtualized NVMe controller versus the number of endpoints that are present in a virtualized NVMe subsystem that would be accessed securely by the encryption key mechanism, the cases being the following:

(1) 1:1 mapping, wherein the number of namespaces reported to the NVMe host machine 210 is equal to the number of endpoints being used by the virtual NVMe target.

(2) H:T (Host to Target) mapping with T>H, wherein the number of namespaces reported to the NVMe host machine 210 is less than the number of endpoints being used by the virtual NVMe target.

(3) H:T mapping with H>T, wherein the number of namespaces reported to the NVMe host machine 210 is greater than the number of endpoints being used by the virtual NVMe target.

Aggregated storage solutions such as hardware RAID controllers generally only support a simple locking mechanism using a single password/credential for the entire volume. In some embodiments, by implementing per-namespace access control, a system expands on the simple locking mechanism to allow each NVMe host to have its own credential so that tenant isolation is better supported.

A conventional storage driver does not include a security mechanism to securely access an endpoint. Further, a conventional SSD (Solid State Drive) includes a namespace that is limited to a single SSD behind a controller that can present multiple namespaces to a host, with its namespace solution not providing a security credential solution that allows a single host to securely access that namespace.

In some embodiments, enhanced access control enforcement to an aggregated storage system may be performed in the following ways:

(1) Enforcement at the point of aggregated storage for an endpoint that provides support for access security, which may include an AES hardware engine with an SSD or other endpoint device; and

(2) Enforcement within the host environment via an aggregated storage proxy, which can utilize existing computer system infrastructure (AES-NI (AES New Instructions) hardware accelerator, device driver software, or other elements.)

In some embodiments, access control enforcement is provided via data encryption and key wrapping. In the above cases, enforcement may be provided via the use of a secret value that is used in a key derivation function to generate a data encryption key used for encryption of all host-provided data to the aggregated storage.

In some embodiments, to alleviate the need for key management infrastructure, a unique host identifier (known only within the context of the Host system) may be used as the secret value to derive the data encryption key used for encryption of all data the host (e.g., an NVMe host machine) stores within the aggregated storage device.

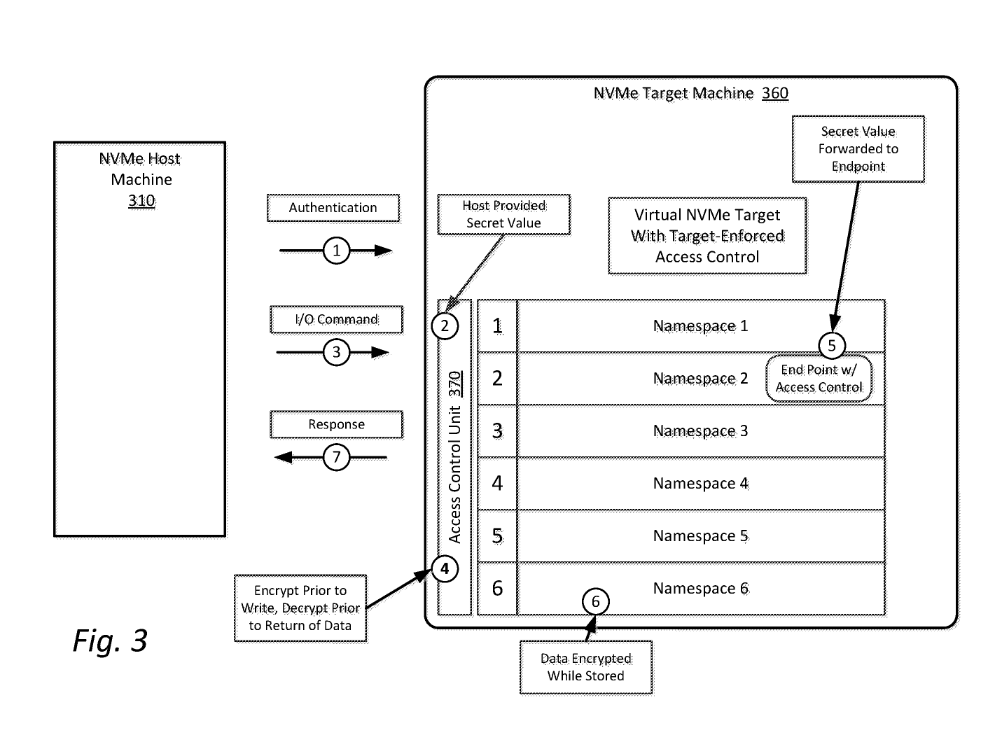

FIG. 3 illustrates an exemplary architecture of a virtual NVMe target with target-enforced access control according to an embodiment. In some embodiments, the architecture utilizes a host identification as a secret value to provide secure operation according to an embodiment. As illustrated in FIG. 3, the NVMe host machine 310 operates with the NVMe target machine 360 including the access control unit 370, the NVMe target machine 360 providing a virtual NVMe target with target enforced access control. As provided in FIG. 3, the NVMe target machine 360 may include multiple namespaces shown as Namespace 1 through Namespace 6. In some embodiments, the process illustrated in FIG. 2 includes the following:

(1) The NVMe host machine 310 authenticates itself to the target 360 by providing the host machine's secret identification value.

(2) The NVMe target machine 360 uses the host provided secret value in a key derivation function to derive the data encryption key used to encrypt/decrypt data for the host's namespace(s).

(3) The NVMe host machine 310 issues an NVMe I/O command to a namespace that is presented by the NVMe target machine 360.

(4) For all writes by the NVMe host machine 310, the access control unit 370 is to encrypt the data prior to writing the data to the endpoint devices, unless the endpoint device supports its own access control. For all reads by the NVMe host machine 310, the access control unit decrypts the data prior to returning the data to the NVMe host machine 310.

(5) For endpoint devices that support media encryption and access control, the NVMe host machine's secret value can be forwarded to the storage device in order to leverage drive based access control. This will also allow the virtual target to leverage the endpoint's hardware accelerated media encryption.

(6) All data stored on the endpoint devices is encrypted while stored, and either the endpoint itself or the access control unit 370 will decrypt the data as part of any read operation to the namespace.

(7) The NVMe target machine 360 provides the appropriate NVMe response to the NVMe host machine 310 for the relevant namespace.

In some embodiments, for enforcement at the point of aggregated storage, access control is enforced by encrypting all data prior to storing it within the underlying endpoint storage devices. The virtual target will not store a plain-text version of a data encryption key in any non-volatile form of storage. Rather, the data encryption key is encrypted utilizing a key encryption key (KEK), and therefore access control will require the NVMe host machine 310 to provide its secret value in order to derive the data encryption key that will unlock data stored within the storage device, as described above regarding the KEK. It is desirable to have the data encryption key(s) on the endpoint device for physical migration purposes, but the data encryption key should not be visible to the world and thus allow situations such as the virtual target “unlocking” a storage device it manages. In some embodiments, an apparatus, system, or process is to allow for physical migration of devices without the data stored on the device being vulnerable to decryption without authentication, as provided by the key encryption key, thereby assisting in limiting access to data to the host owner of such data.

In some embodiments, if the underlying physical storage devices themselves support media encryption with some form of access control, the devices themselves can be used for the encryption. In this case, the host provided secret value can be used as an access credential to the storage device itself. This will allow the virtual target to leverage any pre-existing hardware accelerated encryption engines that the storage device provides. In some embodiments, for any end point that does not support media encryption and access control, hardware acceleration, including system based hardware acceleration such as using AES-NI (AES New Instructions) can be used.

In some embodiments, in the case of security enforcement within the host environment, a proxy driver or component may exist within the host itself, and perform the key derivation processes as well as data encryption/decryption that is needed. In this case, an added benefit is that no host accessing the aggregated storage device will have access to any data that belongs to any other host because each host will only have access to its own data encryption keys and all data going to and from the aggregated storage device will be encrypted.

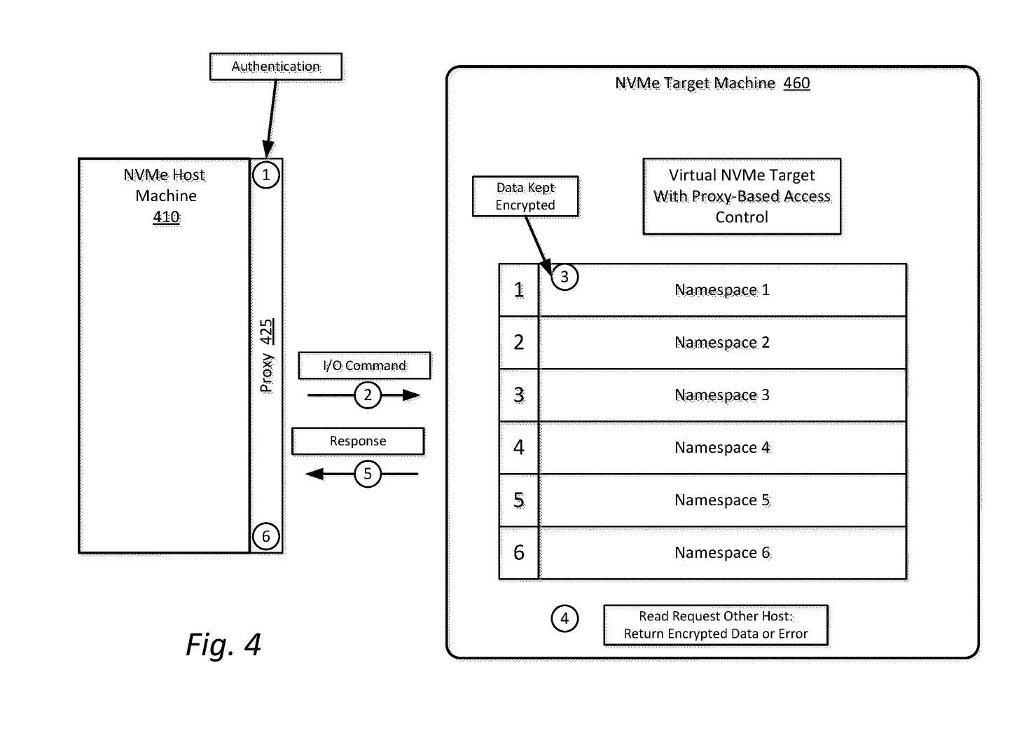

FIG. 4 illustrates an exemplary architecture of a virtual NVMe target with proxy-based access control according to an embodiment. As illustrated in FIG. 4, an NVMe host machine 410 includes a proxy 425 to provide secure access control in conjunction with an NVMe target machine 460 including virtual NVMe target with proxy-based access control. In some embodiments, a process for access control enforcement for NVMe host machine operation includes the following:

(1) NVMe host machine 410 authenticates itself to the proxy 425 by providing its secret value. Proxy 425 derives a data encryption key from the secret value and uses this data encryption key to encrypt all data transferred between the NVMe host machine 410 and the virtual NVMe target.

(2) NVMe host machine 410 issues an NVMe I/O command to a selected namespace presented by the NVMe target machine 460.

(3) All data is kept encrypted when written to or read from the end point storage device.

(4) Read requests by other hosts result in either return back encrypted data or the virtual target can return an error to prevent offline brute force attacks. Write requests by other hosts will return an error in order to prevent a security breach or data corruption. The enforcement at this level may purely be logical because the virtual target is unaware of the data encryption key used to decrypt the data.

(5) NVMe target machine 460 provides the appropriate NVMe response to the NVMe host machine 410 for the selected namespace, wherein data is still in encrypted form.

(6) Proxy 425 decrypts any data that was retrieved from the virtual NVMe target machine 460 prior to providing the data to the NVMe host machine 410.

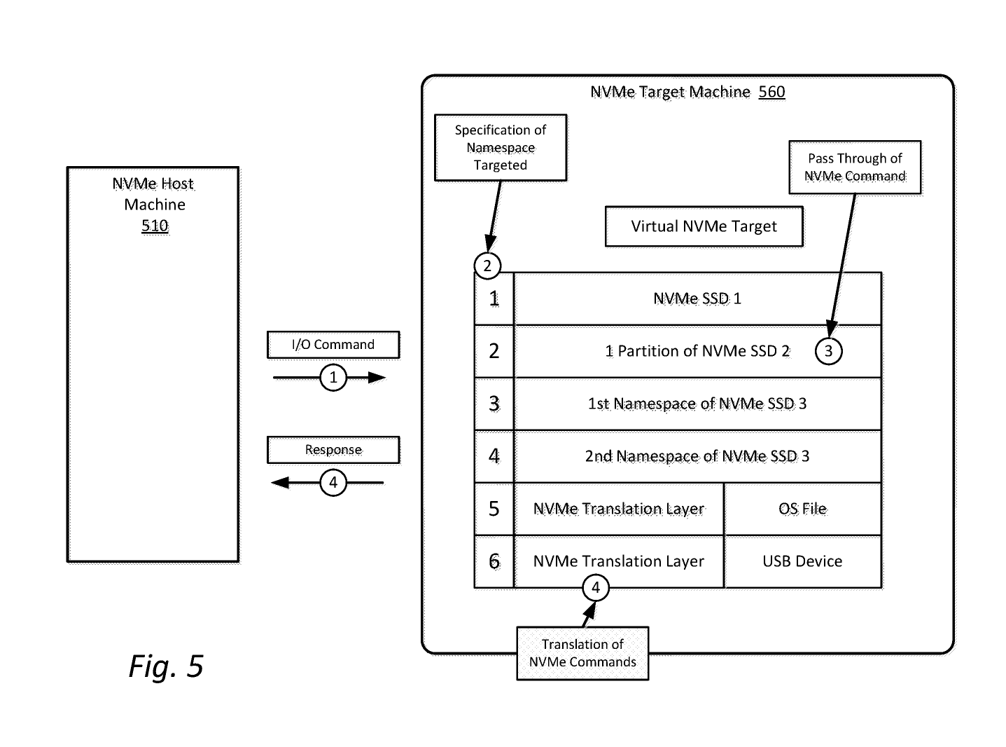

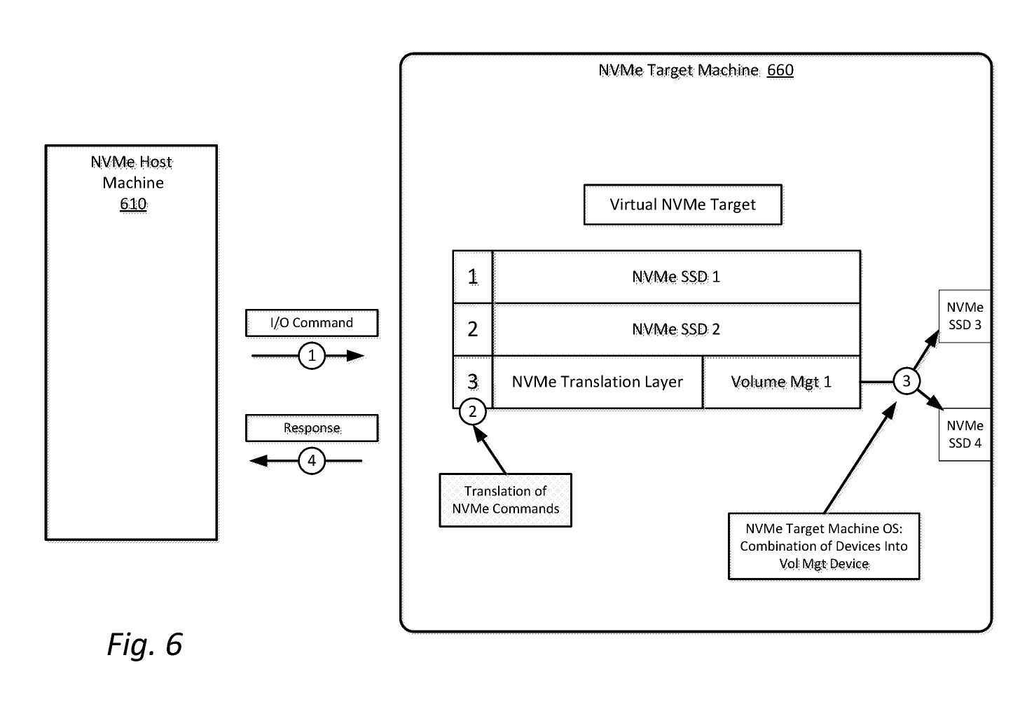

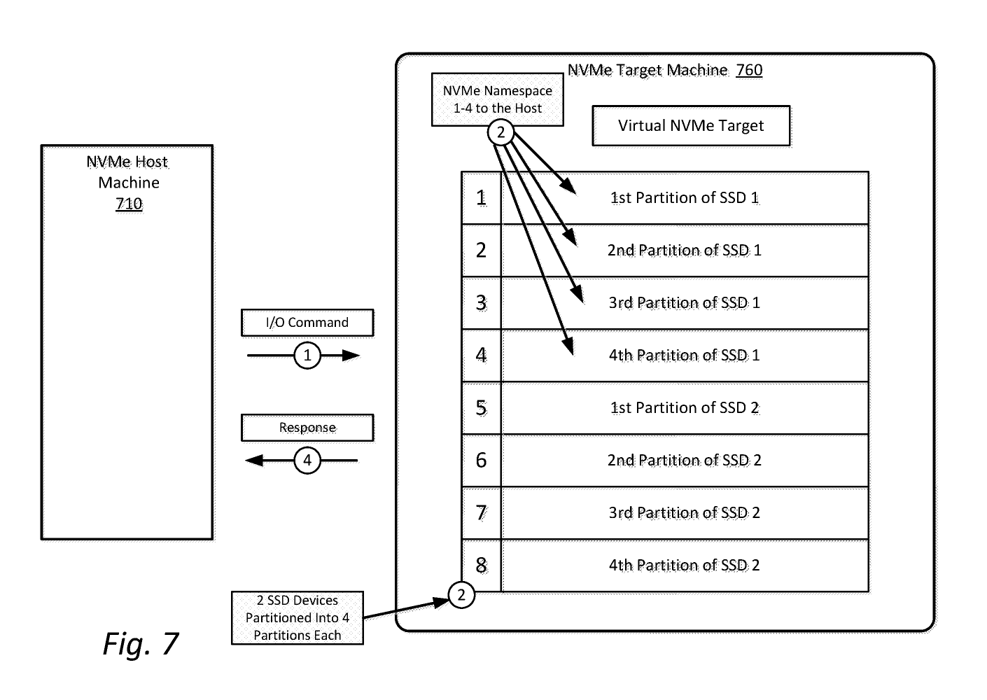

The mechanism for access control enforcement at the virtual target, as illustrated in FIG. 3, and the mechanism for access control enforcement at the NVMe host machine with the proxy operation, as illustrated in FIG. 4, both may apply to multiple host-to-namespace virtual target configurations. Host-to-virtual-namespace-target mappings for namespace I/O operations may include multiple configurations that vary in the number of namespaces presented to the host by the virtualized NVMe controller versus the number of device end points that are present in a virtualized NVMe subsystem natively. In some embodiments, the host to virtual namespace mapping configurations include the Case 1 with 1:1 mapping between host and target (as shown in FIG. 5); Case 2 with target greater than host mapping (as shown in FIG. 6); and Case 3 with host greater than target mapping (as shown in FIG. 7).

FIG. 5 illustrates implementation by a virtual NVMe target of a 1:1 host-to-namespace mapping according to an embodiment. As illustrated in FIG. 5, an NVMe host machine 510 communicates with an NVMe target machine 560, wherein a virtual NVMe target provided by the NVMe target machine 560 includes multiple different types of endpoints, which in this example NVMe SSDs, an OS (operating system) file of a system or apparatus, and a USB (Universal Serial Bus) device. In some embodiments, the mapping implementation includes the following:

(1) The NVMe host machine 510 issues an NVMe I/O command to a selected namespace presented by the NVMe target machine 560.

(2) The NVMe I/O command specifies which namespace it is targeting, which is used by the translation table to route the command to the appropriate endpoint device. (Pursuant to the NVMe specification a namespace cannot be numbered ‘0’.)

(3) For NVMe endpoint devices the NVMe I/O command can be passed through as-is to the back-end device administered by the NVMe target machine 560.

(4) For endpoint devices that are not NVMe devices, the NVMe translation layer converts the NVMe command into an operation the endpoint device understands. For example, if an NVMe Write command is directed to Namespace 5, the target 560 will translate the NVMe I/O command into a normal operating system write command on the file being used by the NVMe target machine 560 for Namespace 5 of the NVMe host machine 510.

(5) The NVMe target machine 560 provides the appropriate NVMe response to the NVMe host machine 510 for the selected namespace.

FIG. 6 illustrates implementation by a virtual NVMe target of a T>H host-to-namespace mapping according to an embodiment. As illustrated in FIG. 6, an NVMe host machine 610 is in communication with an NVMe target machine 660, wherein a virtual NVMe target provided by the NVMe target machine 660 includes more endpoint devices than the number of namespaces recognized by the NVMe host machine 610. In some embodiments, the mapping implementation includes the following:

(1) NVMe host machine 610 issues an NVMe I/O command to a particular selected namespace presented by the NVMe target machine 660.

(2) If an NVMe I/O command is directed to, for example, the third namespace in the illustrated example, the virtual target is to translate the NVMe command to a native instruction for a volume management device, the volume management device being used to present multiple endpoints as a single namespace.

(3) In this example, the OS of the NVMe target machine 660 is being used for the NVMe target machine 660 to combine two NVMe devices into one volume management device the NVMe host machine 610 can access as the third namespace of a single target NVMe controller.

(4) The NVMe target machine 660 provides the appropriate NVMe response to the NVMe target machine 610 for the selected namespace.

In FIG. 6 the NVMe host machine 610 is presented with a number of NVMe namespaces that is smaller than a number of actual endpoint devices being used by the virtual NVMe target. A possible use case of this configuration with the secure access policies described above is for secure access and encryption volume management.

FIG. 7 illustrates implementation by a virtual NVMe target of an H>T host-to-namespace mapping according to an embodiment. As illustrated in FIG. 7, an NVMe host machine 710 is in communication with an NVMe target machine 760, wherein a virtual NVMe target presented by the NVMe target machine 760 includes fewer endpoint devices than the number of namespaces recognized by the NVMe host machine 710. In some embodiments, the mapping implementation includes the following:

(1) NVMe host machine 710 issues an NVMe I/O command to a particular selected namespace presented by the NVMe target machine 760.

(2) In this example, two SSD devices (as physical endpoint devices) that are designed for single namespace support have been partitioned by software (such as the operating system) to provide four partitions each. This operation provides a single virtual NVMe controller with eight virtual namespaces to be presented to the NVMe host machine 710.

(3) In this example, each of the two SSD devices is configured with four virtual namespaces, with partitions 1-4 of the first SSD being presented to the NVMe host machine 710 as NVMe namespaces 1-4, and partitions 1-4 of the second SSD being presented to the NVMe host machine 710 as NVMe namespaces 5-8. In a particular operating system, such as Linux, a separate software handle can be opened to each partition of a single storage device for operations in that partition.

(4) The NVMe target machine 760 provides the appropriate NVMe response to the NVMe host machine 710 for the selected namespace.

In FIG. 7 the NVMe host machine 710 is presented with more NVMe namespaces than the number of actual endpoint devices (two SSDs in this example) that are being used by the Virtual NVMe Target. A possible use case of this configuration may include, but is not limited to, a situation in which a particular drive has only a single namespace can be presented to the host as having multiple namespaces. Further, if the drives do not have secure access features, the access control enforcement at the NVMe host machine 710 may be utilized to provide access control and encryption services.

In each of the host-to-namespace mapping cases (as illustrated in FIGS. 5, 6, and 7), the virtual NVMe target may provide access control even if one or more endpoint devices do not include any built in security access control mechanisms built in. If access control is built in to the endpoint device, then that access control mechanism may be leveraged for any namespace that is partially or fully stored within that endpoint device.

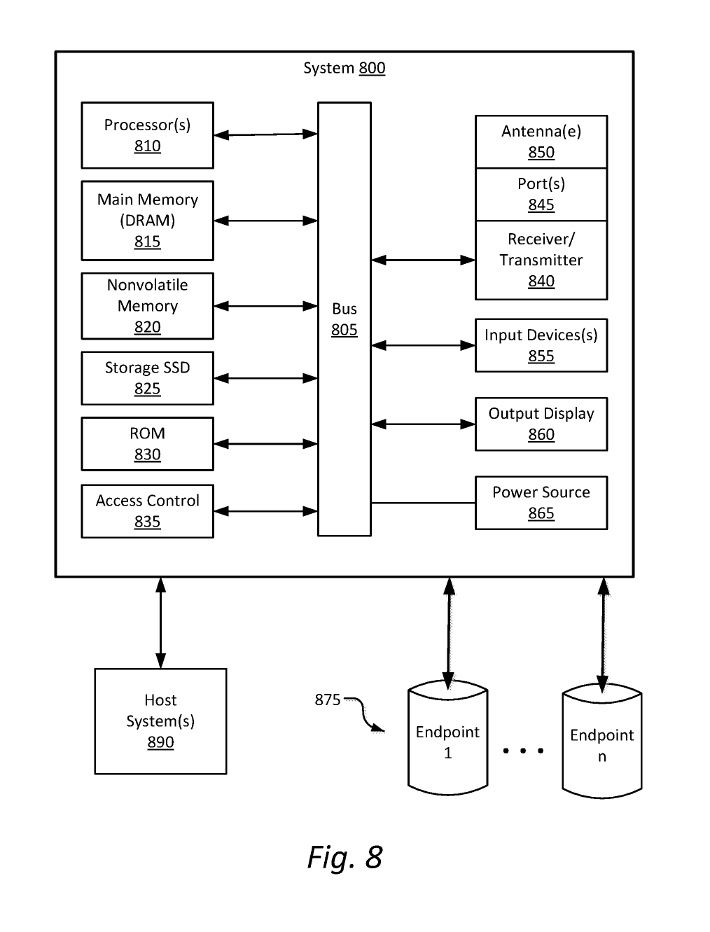

FIG. 8 is an illustration of a system to provide a virtual target for a host system according to an embodiment. In this illustration, certain standard and well-known components that are not germane to the present description are not shown. Elements shown as separate elements may be combined, including, for example, an SoC (System on Chip) or SoP (System on Package) combining multiple elements on a single chip or package.

In some embodiments, a system 800 includes an interface with one or more host systems 890 and with each of one or more physical endpoints 875. In some embodiments, the system 800 is operable to act as a target system to present the one or more physical endpoints 875 to a host system 890, the one or more endpoints shown as Endpoint 1 through Endpoint n, the physical endpoints being presented as a set of virtual namespaces to the host system. In some embodiments, the number of virtual namespaces presented to the host system 890 may be equal to, greater than, or less than the number of endpoints. The endpoints are devices or sub-sections of a device to provide storage. In some embodiments, an endpoint is a device or sub-section of a device to provide data storage that a virtual NVMe target can use to provide a virtual NVMe namespace to an NVMe host. The endpoints 875 may include, but are not limited to, SSD devices, USB devices, and files such as OS files of an apparatus or system. In some embodiments, the system 800 may operate as, for example, the target machine 160 illustrated in FIG. 1 or the NVMe target machine 260 illustrated in FIG. 2. In some embodiments, the system 800 further includes an access control unit 835 for controlling access to the endpoints 875.

The system 800 may include a processing means such as one or more processors 810 coupled to one or more buses or interconnects, shown in general as bus 805. The processors 810 may comprise one or more physical processors and one or more logical processors. In some embodiments, the processors 810 may include one or more general-purpose processors or special-processor processors. The bus 805 is a communication means for transmission of data. The bus 805 is illustrated as a single bus for simplicity, but may represent multiple different interconnects or buses and the component connections to such interconnects or buses may vary. The bus 805 shown in FIG. 8 is an abstraction that represents any one or more separate physical buses, point-to-point connections, or both connected by appropriate bridges, adapters, or controllers.

In some embodiments, the system 800 further comprises a random access memory (RAM) or other dynamic storage device or element as a main memory 815 for storing information and instructions to be executed by the processors 810. Main memory 815 may include, but is not limited to, dynamic random access memory (DRAM).

The system 800 also may comprise a non-volatile memory 820; a storage device such as a solid state drive (SSD) 825; and a read only memory (ROM) 830 or other static storage device for storing static information and instructions for the processors 810.

In some embodiments, the system 800 includes one or more transmitters or receivers 840 coupled to the bus 805. In some embodiments, the system 800 may include one or more antennae 850, such as dipole or monopole antennae, for the transmission and reception of data via wireless communication using a wireless transmitter, receiver, or both, and one or more ports 845 for the transmission and reception of data via wired communications. Wireless communication includes, but is not limited to, Wi-Fi, Bluetooth™, near field communication, and other wireless communication standards. In some embodiments, a wired or wireless connection port is to link the system 800 to a host system via communication fabric, such as the communication fabric 150 illustrated in FIG. 1 or the communication fabric 250 illustrated in FIG. 2.

In some embodiments, system 800 includes one or more input devices 855 for the input of data, including hard and soft buttons, a joy stick, a mouse or other pointing device, a keyboard, voice command system, or gesture recognition system. In some embodiments, system 800 includes an output display 860, where the output display 860 may include a liquid crystal display (LCD) or any other display technology, for displaying information or content to a user. In some environments, the output display 860 may include a touch-screen that is also utilized as at least a part of an input device 855. Output display 860 may further include audio output, including one or more speakers, audio output jacks, or other audio, and other output to the user.

The system 800 may also comprise a battery or other power source 865, which may include a solar cell, a fuel cell, a charged capacitor, near field inductive coupling, or other system or device for providing or generating power in the system 800. The power provided by the power source 865 may be distributed as required to elements of the system 800.

In the description above, for the purposes of explanation, numerous specific details are set forth in order to provide a thorough understanding of the described embodiments. It will be apparent, however, to one skilled in the art that embodiments may be practiced without some of these specific details. In other instances, well-known structures and devices are shown in block diagram form. There may be intermediate structure between illustrated components. The components described or illustrated herein may have additional inputs or outputs that are not illustrated or described.

Various embodiments may include various processes. These processes may be performed by hardware components or may be embodied in computer program or machine-executable instructions, which may be used to cause a general-purpose or special-purpose processor or logic circuits programmed with the instructions to perform the processes. Alternatively, the processes may be performed by a combination of hardware and software.

Portions of various embodiments may be provided as a computer program product, which may include a computer-readable medium having stored thereon computer program instructions, which may be used to program a computer (or other electronic devices) for execution by one or more processors to perform a process according to certain embodiments. The computer-readable medium may include, but is not limited to, magnetic disks, optical disks, read-only memory (ROM), random access memory (RAM), erasable programmable read-only memory (EPROM), electrically-erasable programmable read-only memory (EEPROM), magnetic or optical cards, flash memory, or other type of computer-readable medium suitable for storing electronic instructions. Moreover, embodiments may also be downloaded as a computer program product, wherein the program may be transferred from a remote computer to a requesting computer.

Many of the methods are described in their most basic form, but processes can be added to or deleted from any of the methods and information can be added or subtracted from any of the described messages without departing from the basic scope of the present embodiments. It will be apparent to those skilled in the art that many further modifications and adaptations can be made. The particular embodiments are not provided to limit the concept but to illustrate it. The scope of the embodiments is not to be determined by the specific examples provided above but only by the claims below.

If it is said that an element “A” is coupled to or with element “B,” element A may be directly coupled to element B or be indirectly coupled through, for example, element C. When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic is not required to be included. If the specification or claim refers to “a” or “an” element, this does not mean there is only one of the described elements.

An embodiment is an implementation or example. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of exemplary embodiments, various features are sometimes grouped together in a single embodiment, figure, or description thereof for the purpose of streamlining the disclosure and aiding in the understanding of one or more of the various novel aspects. This method of disclosure, however, is not to be interpreted as reflecting an intention that the claimed embodiments requires more features than are expressly recited in each claim. Rather, as the following claims reflect, novel aspects lie in less than all features of a single foregoing disclosed embodiment. Thus, the claims are hereby expressly incorporated into this description, with each claim standing on its own as a separate embodiment.

In some embodiments, an apparatus includes a processor to process data; a memory for storage of data; an interface with a host system over a communication fabric; an interface with each of one or more endpoint devices to provide storage for the host system; and a virtual target, the virtual target to map the one or more endpoint devices to a plurality of namespaces for the host system. The apparatus is operable to support secure access to the namespaces, the secure access including encryption of data transferred between the host system and each namespace, a data encryption key being derived from an identification of the host system; and present the plurality of namespaces to the host system in the virtual target.

In some embodiments, the data encryption key is encrypted with a key encryption key, the key encryption key being derived from the identification of the host system.

In some embodiments, the apparatus includes an access control unit to provide the secure access to the one or more endpoint devices.

In some embodiments, encryption and decryption of data transferred between the host system and a selected namespace is performed by one of for an endpoint device that supports encryption and access control, the endpoint device to encrypt and decrypt data; or otherwise, the access control unit to encrypt and decrypt the data.

In some embodiments, the host system includes a proxy, the proxy to provide the secure access to the one or more endpoint devices.

In some embodiments, the proxy is to derive the data encryption key and use the data encryption key to encrypt data transferred between the host system and the virtual target.

In some embodiments, the virtual target is to hide an actual number of and types of devices being securely accessed by the host system.

In some embodiments, the apparatus is to support a number of namespaces for the host system that is any of the following: equal to a number of endpoint devices used by the virtual target; less than the number of endpoint devices used by the virtual target; or greater than the number of endpoint devices used by the virtual target.

In some embodiments, the number of namespaces presented to the host system is equal to the number of endpoint devices used by the virtual target, and wherein each of the plurality of namespaces represents a respective endpoint device.

In some embodiments, the number of namespaces presented to the host system is less than the number of endpoint devices being used by the virtual target, and wherein at least two endpoint devices are combined into a volume management device for the virtual target.

In some embodiments, the number of namespaces presented to the host system is greater than the number of endpoint devices being used by the virtual target, and wherein at least one endpoint device is partitioned into a plurality of namespaces for the virtual target.

In some embodiments, one or more endpoints include one or more of an SSD (Solid State Drive) device, a USB (Universal Serial Bus) device, and an operating system file.

In some embodiments, a non-transitory computer-readable storage medium having stored thereon data representing sequences of instructions that, when executed by a processor, cause the processor to perform operations including generating a virtual target, including mapping one or more endpoint devices to a plurality of namespaces for a host system; presenting the plurality of namespaces to the host system in the virtual target; receiving an I/O (Input/Output) command from the host system, the I/O command being directed to a selected namespace of the plurality of namespaces; providing secure access to the selected namespace, the secure access including encryption of data transferred between the host system and the selected namespace, a data encryption key for the encryption of the data being derived from an identification of the host system; and returning a response for the I/O command to the host system.

In some embodiments, the data encryption key is encrypted with a key encryption key, the key encryption key being derived from the identification of the host system.

In some embodiments, providing secure access to the selected namespace includes enforcing access control at the virtual target by encrypting all data written to and read from each namespace prior to transferring data to or from the one or more endpoint devices.

In some embodiments, the endpoint device for the selected namespace supports encryption and access control, wherein providing secure access to the selected namespace includes the selected endpoint device to encrypt and decrypt data.

In some embodiments, the host system includes a proxy, and wherein the proxy is to provide the secure access to the one or more endpoint devices.

In some embodiments, presenting the plurality of namespaces to the host system in the virtual target includes hiding an actual number of and types of devices being securely accessed by the host system.

In some embodiments, an endpoint device to which the selected namespace is mapped does not support the I/O command, and further comprising translating the I/O command into a format supported by the endpoint device.

In some embodiments, a number of namespaces is equal to a number of endpoint devices used by the virtual target, and further comprising representing each of the endpoint devices with a respective namespace.

In some embodiments, a number of namespaces is less than a number of endpoint devices being used by the virtual target, and further comprising combining at least two endpoint devices into a volume management device for the virtual target.

In some embodiments, a number of namespaces is greater than a number of endpoint devices being used by the virtual target, and further comprising partitioning at least one endpoint device into two or more namespaces for the virtual target.

In some embodiments, an apparatus includes means for generating a virtual target, including means for mapping one or more endpoint devices to a plurality of namespaces for a host system; means for presenting the plurality of namespaces to the host system in the virtual target; means for receiving an I/O (Input/Output) command from the host system, the I/O command being directed to a selected namespace of the plurality of namespaces; means for providing secure access to the selected namespace, the secure access including encryption of data transferred between the host system and the selected namespace, a data encryption key for the encryption of the data being derived from an identification of the host system; and means for returning a response for the I/O command to the host system.

In some embodiments, the data encryption key is encrypted with a key encryption key, the key encryption key being derived from the identification of the host system.

In some embodiments, the means for providing secure access to the selected namespace includes means for enforcing access control at the virtual target by encrypting all data written to and read from each namespace prior to transferring data to or from the one or more endpoint devices.

In some embodiments, the endpoint device for the selected namespace supports encryption and access control, and the means providing secure access to the selected namespace includes the selected endpoint device to encrypt and decrypt data.

In some embodiments, the host system includes a proxy, and wherein the proxy is to provide the secure access to the one or more endpoint devices.

In some embodiments, wherein the means for presenting the plurality of namespaces to the host system in the virtual target includes means for hiding an actual number of and types of devices being securely accessed by the host system.

In some embodiments, an endpoint device to which the selected namespace is mapped does not support the I/O command, and further comprising means for translating the I/O command into a format supported by the endpoint device.

In some embodiments, a number of namespaces is equal to a number of endpoint devices used by the virtual target, and further comprising means for representing each of the endpoint devices with a respective namespace.

In some embodiments, a number of namespaces is less than a number of endpoint devices being used by the virtual target, and further comprising means for combining at least two endpoint devices into a volume management device for the virtual target.

In some embodiments, a number of namespaces is greater than a number of endpoint devices being used by the virtual target, and further comprising means for partitioning at least one endpoint device into two or more namespaces for the virtual target.

In some embodiments, a system includes a processor to process data; a memory for storage of data; an interface with one or more host systems over a communication fabric; an interface with each of one or more endpoint devices to provide storage for each of the one or more host systems; and a virtual target for a first host system of the one or more host system, the virtual target to map the one or more endpoint devices to a plurality of namespaces for the first host system. In some embodiments, the system is provide secure access to the namespaces that is limited to the first host system, the secure access including encryption of data transferred between the first host system and each namespace, a data encryption key being derived from an identification of the first host system, wherein the data encryption key is encrypted with a key encryption key, the key encryption key being derived from the identification of the first host system, and wherein the system is to present the plurality of namespaces to the first host system in the virtual target.

In some embodiments, the system further includes an access control unit to provide the secure access to the one or more endpoint devices for the first host system.

In some embodiments, the first host system includes a proxy, the proxy of the first host system to provide the secure access to the one or more endpoint devices for the first host system.

In some embodiments, the system further includes a transmitter and receiver to transmit and receive data, and a dipole antenna for transmission and reception of data.

1. An apparatus comprising:
a processor to process data;
a memory for storage of data;
an interface with a host system over a communication fabric;
an interface with each of one or more endpoint devices to provide storage for the host system; and
a virtual target, the virtual target to map the one or more endpoint devices to a plurality of namespaces for the host system;
wherein the apparatus is to:
support secure access to the namespaces, the secure access including encryption of data transferred between the host system and each namespace, a data encryption key being derived from an identification of the host system; and
present the plurality of namespaces to the host system in the virtual target.

2. The apparatus of claim 1, wherein the data encryption key is encrypted with a key encryption key, the key encryption key being derived from the identification of the host system.

3. The apparatus of claim 1, wherein the apparatus includes an access control unit to provide the secure access to the one or more endpoint devices.

4. The apparatus of claim 3, wherein encryption and decryption of data transferred between the host system and a selected namespace is performed by one of:
for an endpoint device that supports encryption and access control, the endpoint device to encrypt and decrypt data; or
otherwise, the access control unit to encrypt and decrypt the data.

5. The apparatus of claim 1, wherein the host system includes a proxy, the proxy to provide the secure access to the one or more endpoint devices.

6. The apparatus of claim 5, wherein the proxy is to derive the data encryption key and use the data encryption key to encrypt data transferred between the host system and the virtual target.

7. The apparatus of claim 1, wherein the virtual target is to hide an actual number of and types of devices being securely accessed by the host system.

8. The apparatus of claim 1, wherein the apparatus is to support a number of namespaces for the host system that is any of the following:
equal to a number of endpoint devices used by the virtual target;
less than the number of endpoint devices used by the virtual target; or
greater than the number of endpoint devices used by the virtual target.

9. The apparatus of claim 8, wherein the number of namespaces presented to the host system is equal to the number of endpoint devices used by the virtual target, and wherein each of the plurality of namespaces represents a respective endpoint device.

10. The apparatus of claim 8, wherein the number of namespaces presented to the host system is less than the number of endpoint devices being used by the virtual target, and wherein at least two endpoint devices are combined into a volume management device for the virtual target.

11. The apparatus of claim 8, wherein the number of namespaces presented to the host system is greater than the number of endpoint devices being used by the virtual target, and wherein at least one endpoint device is partitioned into a plurality of namespaces for the virtual target.

12. The apparatus of claim 1, wherein one or more endpoints include one or more of an SSD (Solid State Drive) device, a USB (Universal Serial Bus) device, and an operating system file.

13. A non-transitory computer-readable storage medium having stored thereon data representing sequences of instructions that, when executed by a processor, cause the processor to perform operations comprising:
generating a virtual target, including mapping one or more endpoint devices to a plurality of namespaces for a host system;
presenting the plurality of namespaces to the host system in the virtual target;
receiving an I/O (Input/Output) command from the host system, the I/O command being directed to a selected namespace of the plurality of namespaces;
providing secure access to the selected namespace, the secure access including encryption of data transferred between the host system and the selected namespace, a data encryption key for the encryption of the data being derived from an identification of the host system; and
returning a response for the I/O command to the host system.

14. The medium of claim 13, wherein the data encryption key is encrypted with a key encryption key, the key encryption key being derived from the identification of the host system.

15. The medium of claim 13, wherein providing secure access to the selected namespace includes enforcing access control at the virtual target by encrypting all data written to and read from each namespace prior to transferring data to or from the one or more endpoint devices.

16. The medium of claim 13, wherein the endpoint device for the selected namespace supports encryption and access control, wherein providing secure access to the selected namespace includes the selected endpoint device to encrypt and decrypt data.

17. The medium of claim 13, wherein the host system includes a proxy, and wherein the proxy is to provide the secure access to the one or more endpoint devices.

18. The medium of claim 13, wherein presenting the plurality of namespaces to the host system in the virtual target includes hiding an actual number of and types of devices being securely accessed by the host system.

19. The medium of claim 13, wherein an endpoint device to which the selected namespace is mapped does not support the I/O command, and further comprising translating the I/O command into a format supported by the endpoint device.

20. The medium of claim 13, wherein a number of namespaces is equal to a number of endpoint devices used by the virtual target, and further comprising representing each of the endpoint devices with a respective namespace.

21. The medium of claim 13, wherein a number of namespaces is less than a number of endpoint devices being used by the virtual target, and further comprising combining at least two endpoint devices into a volume management device for the virtual target.

22. The medium of claim 13, wherein a number of namespaces is greater than a number of endpoint devices being used by the virtual target, and further comprising partitioning at least one endpoint device into two or more namespaces for the virtual target.

23. A system comprising:
a processor to process data;
a memory for storage of data;
an interface with one or more host systems over a communication fabric;
an interface with each of one or more endpoint devices to provide storage for each of the one or more host systems; and
a virtual target for a first host system of the one or more host system, the virtual target to map the one or more endpoint devices to a plurality of namespaces for the first host system;
wherein the system is to provide secure access to the namespaces that is limited to the first host system, the secure access including encryption of data transferred between the first host system and each namespace, a data encryption key being derived from an identification of the first host system, wherein the data encryption key is encrypted with a key encryption key, the key encryption key being derived from the identification of the first host system; and
wherein the system is to present the plurality of namespaces to the first host system in the virtual target.

24. The system of claim 23, further comprising an access control unit to provide the secure access to the one or more endpoint devices for the first host system.

25. The system of claim 23, wherein the first host system includes a proxy, the proxy of the first host system to provide the secure access to the one or more endpoint devices for the first host system.

26. The system of claim 23, further comprising a transmitter and receiver to transmit and receive data, and a dipole antenna for transmission and reception of data.
